(19) United States
(12) Patent Application Publication
(10) Pub. No.: US 2023/0022750 A1
(43) Pub. Date: Jan. 26, 2023

(54) Dynamic Logic Element For Controlling Pressure Limit In Hydraulic System

(71) Applicant: Parthiban Varadharajan, Tamilnadu (IN)

(72) Inventor: Parthiban Varadharajan, Tamilnadu (IN)

(21) Appl. No.: 17/758,385

(22) PCT Filed: Jan. 4, 2021
(86) PCT No.: PCT/IN2021/050008

§ 371 Date: Jul. 5, 2022

(30) Foreign Application Priority Data
Sep. 4, 2020 (IN) 202041038187

(51) Int. Cl. F15B 21/047; F15B 11/024; F15B 21/08

(52) U.S. Cl. CPC F15B 21/047; F15B 11/024; F15B 21/08; F15B 2211/8609; F15B 2211/575; F15B 2211/632

(57) ABSTRACT

The present invention relates to a stand-alone or inbuilt logical element associated with a hydraulic system for effective regeneration to improve the efficiency of any hydraulic system of a machine or equipment, including but not limited to farm machinery, industrial machinery, construction and mining machinery which uses hydraulic system. The logical element senses the cavitation or low pressure in the hydraulic system and automatically regulates and diverts the portion of hydraulic oil flow to caveated and required areas by regenerating through the anti-cavitation feature of the valve by automatically sensing and applying selective restriction to the set or adjustable pressure limit for the passage of oil.

### FIELD OF THE INVENTION

The invention relates to a dynamic logical element associated with a hydraulic system for increasing the flow and effectiveness of regeneration through dynamic, selective and on demand adjustable restriction.

### BACKGROUND OF THE INVENTION

In a hydraulic system, it is always desirable to have cavitation free system to increase the efficiency. Many anti cavitation and regenerative valve or spools are available which can be used on specific service line of control valves. But there is no system available to regenerate to the required level using the existing features of the valve.

A non-adjustable logic element offers restriction in proportion to the flow. When a system is having limited capability on pressure limit in the tank/return line, restriction has to be designed for the maximum flow. Hence, at lower flow, the quantum of restriction will be lesser than the allowable limit of the system and the regeneration will be relatively less effective. The conventional method was not recognizing the various dynamic flow changing needs for variable restrictions and was applying constant preset restrictions. Even in a constant speed operation, a system if contains different sized cylinders, the return line flow to tank may vary drastically based on cylinder size to rod size ratio. As the fixed setting restrictor offers resistance in proportion to the flow and while the restriction is designed for the maximum return line flow comes out of the various available cylinders, only the cylinder with maximum return line flow operates at effective regeneration and the cylinder with lower return line flow will get ineffective/poor regeneration.

Therefore, there is a need for a system with dynamically adjustable type logic element which can apply the restriction based on flow or demand to maintain a constant maximum allowable pressure limit, which ensures effective regeneration or diversion of fluid across entire range of operation to maximize the efficiency of the hydraulic system.

### OBJECT OF THE INVENTION

The main objective of the present invention is to maintain a constant maximum allowable pressure limit, which ensures effective regeneration or diversion of oil across entire range of operation by applying the restriction based on flow or demand.

Further objective of the present invention is to improve the efficiency of hydraulic system by reducing the cavitation in hydraulic machinery by regulating and regenerating the flow to the optimum level in cost effective manner either by using internal or external anti-cavitation feature of the hydraulic system with the on demand dynamically adjustable restriction.

The present invention has further objective of improving the efficiency of hydraulic system by reducing the cavitation in hydraulic machinery by regulating the flow to the optimum level in cost effective manner. According to the configuration of present invention, it has been improved substantially with an adjustable pressure/restriction thus maximizing the efficiency. The efficiency can be further enhanced by using an external anti cavitation valve or check valve.

Another object of the invention is that in a hydraulic system, the logical element enables selective automatic restriction to the preset pressure and regulates the flow of fluid using the anti-cavitation feature of any hydraulic valve which results in improved efficiency by providing the fluid to the required areas or cavitated areas.

Yet another object of the invention is that the logic element senses the pressure from the pressure line and applies preset restrictions automatically as and when required.

Yet another object of the invention is that the logic element which automatically restricts and diverts the flow of fluid to the required and cavitated areas for maximizing the efficiency.

Yet another object of the invention is that the hydraulic system which uses the anti-cavitation feature of the valve for regeneration purpose.

Yet another object of the invention is that a single system which automatically senses the cavitation in any section of the valve and diverts required oil to the desired section of the valve.

Yet another object of the invention is that a single logic element provides regeneration to the complete system.

Yet another object of the invention is to improve the efficiency of any hydraulic system of a machine or equipment, including but it is not limited to farm machinery, industrial machinery, construction and mining machinery which use hydraulic system.

Yet another object of the invention is to provide the logical element which is standalone or integral part of a valve that restricts automatically or otherwise uses the anti-cavitation feature of the valve and diverts the oil for the required area or cavitated area.

Yet another object of the invention relates is to provide the logical element which automatically diverts the fluid flow using the anti-cavitation feature of the valves by selectively restricts the flow of the fluid passage which can be used in hydraulic system including but it is not limited to farm machinery, industrial machinery, construction and mining machinery.

### SUMMARY OF THE INVENTION

The present invention relates to a logic element in hydraulic system which senses the cavitation in the hydraulic system and automatically regulates and diverts the portion of hydraulic oil to the cavitated and required areas to get enhanced regeneration through the anti-cavitation feature of the valve or an external check valve by automatically sensing and applying selective dynamic adjustable restriction to the set pressure limit for the passage of oil to the optimum level.

In one aspect, the embodiment herein provides an apparatus for regulating flow of fluid. The apparatus includes a dynamic logical element, and at least one sensor and controller. The dynamic logical element having a pilot operated valve where a pilot line is connected to a pump line of a pump. The pilot operated valve senses a level of pressure restriction pressure needed in tank line of a direction control valve to activate said dynamic logical element inversely proportionally to set pressure limit for the passage of said fluid to an optimum level in order to regulate the pressure and flow of said fluid in said tank line based on demand or flow of said fluid. The least one sensor and controller detects variable return line flow characteristics such as maximum return line flow rate and minimum return line flow rate of a cylinder and a motor.

The dynamic logical element controls the level of pressure restriction of fluid based on the variable return line flow characteristics of the cylinder which is connected to a first valve section and the motor which is connected to a second valve section of the direction control valve in order to maintain constant maximum allowable pressure limit.

The logical element which provides regeneration on demand without affecting the efficiency of the whole system. The logical element with mode of varying the pressure setting using sensors and controller to further optimize the regeneration based on application requirement and other system parameters. The efficiency of usage of anti-cavitation feature/function of the valve is substantially enhanced by using the logical element. A logic/predefined function which can be used in a hydraulic system which enables selective automatic restriction to the preset or adjustable pressure and diversion of outgoing fluid using the anti-cavitation feature of any hydraulic system which results in improved efficiency by providing the oil to the required areas or cavitated areas.

The logical element which senses the pressure from the pressure line and applies preset or adjustable restrictions automatically as and when required. The logical element which automatically restricts and diverts the flow to the required and cavitated areas for maximizing the efficiency. A system which uses the anticavitation feature of the valve for regeneration purpose. Thus, a single system which automatically senses the cavitation or low pressure in any section of the valve and divert required oil to the desired section of the valve. A single logic element provides regeneration to the complete system. The logical element which is standalone or integral part of a valve that restricts automatically or otherwise and uses the anticavitation feature of the valve and divert the oil for the required area or cavitated area.

The logical element which automatically diverts the fluid flow using the anti-cavitation feature of the valves by selectively restricting the flow of the fluid passage which can be used in hydraulic system including but not restricted to farm machinery, industrial machinery, construction and mining machinery. The logical element which automatically diverts the fluid by using optional external check valve with suitable flow capacity to further enhance the efficiency by effective regeneration.

The apparatus further comprises a check valve which is mounted between tank line and service port of a second valve section. In one embodiment, the check valve allows maximum flow when there is a pressure restriction applied by the dynamic adjustable logical element.

In another embodiment, the dynamic logical element senses cavitation being occurred in said cylinder to redirect the flow of the fluid to the cavitation side of the cylinder via anti-cavitation valves to increase efficiency.

In yet another embodiment, the dynamic logical element senses cavitation being occurred in the motor to redirect the flow of the fluid to said cavitation via anti-cavitation valves to increase efficiency.

In some embodiment, the tank line of the direction control valve is connected back to a tank through a cooler and a return line filter.

In yet another embodiment, the dynamic logical element senses the cavitation being occurred in the direction control valve and redirects required fluid to desired section of the direction control valve to reduce the cavitation in the direction control valve.

In yet another embodiment, the least one pressure sensor is mounted on a specific service port which provides an input signal to the controller when there is a flow in the port and the controller sends an appropriate signal to the dynamic logical element to apply selective restriction.

In some embodiment, the fluid is oil.

In another aspect, a system for regulating flow of fluid for reducing cavitation is provided. The system includes a direction control valve, a dynamic logical element, a pump, a hydraulic cylinder, and a hydraulic motor. The pump is connected to the direction control valve which has a main relief valve and a High Pressure Carry Over (HPCO) line of the valve is connected back to a tank via oil cooler and a return line filter. A tank line of the valve is connected to the dynamic logical element which senses the pressure from a point between the pump and the main relief valve. The dynamic logical element having a pilot operated valve where a pilot line is connected to a pump line of the pump.

The dynamic logical element senses a level of pressure restriction in tank line of said direction control valve to activate said direction control valve inversely proportionally to set pressure limit for the passage of said fluid to an optimum level in order to regulate the pressure and flow of said fluid in said tank line.

The system has at least one sensor and controller that detects variable return line flow characteristics such as maximum return line flow rate and minimum return line flow rate of the hydraulic cylinder and the hydraulic motor.

The dynamic logical element controls the level of pressure restriction of fluid based on the variable return line flow characteristics of the cylinder which is connected to a first valve section and the motor which is connected to a second valve section of the direction control valve in order to maintain constant maximum allowable pressure limit.

### BRIEF DESCRIPTION OF DRAWINGS

FIG. 1 illustrates a hydraulic circuit of the system according to an embodiment herein.

### DETAILED DESCRIPTION OF THE INVENTION

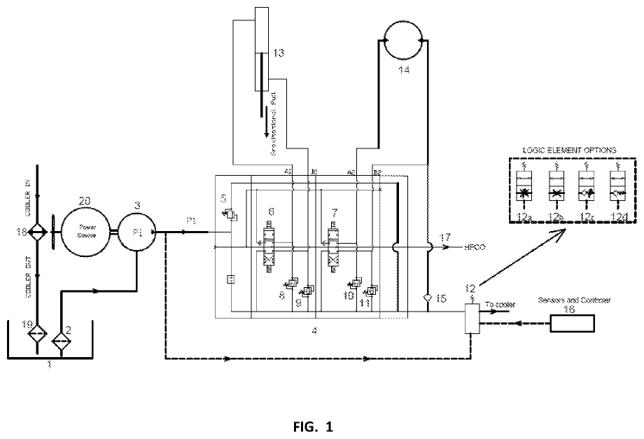

FIG. 1 shows a circuit representing the working principle of the invention. A pump (3) is coupled to the power source (20) by suitable means and takes fluid (i.e. oil) from the tank (1) by a hose connection through a suction strainer (2).

The pump (3) outlet is connected to the valve (4) which has a main relief valve (5) and the HPCO (17) line of the valve is connected back to the tank (1) via oil cooler (18) and a return line filter (19). The tank line of the valve (4) is connected to the dynamically logical element (12) and the logic element (12) senses the system pressure from a point between pump (3) and valve (5).

The logic element can be an adjustable (12a) or non-adjustable orifice type (12b) or a check valve with adjustable (12c) or non-adjustable crack pressure type (12d).

The magnitude of restriction can be varied dynamically to enhance the usage of the system by using sensors and controller (16).

The output of logic element (12) is connected to tank (1) via cooler (18) and return line filter (19). The valve (4) has two valve sections (6, 7) in a parallel circuit. The two valve sections are (i) a first valve section (6) and (ii) a second valve section (7). Each valve section (6, 7) having a set of anti-cavitation cum shock relief valve (8, 9, 10, 11) fitted in the service port.

The logical element (12) is a pilot operated valve where the pilot line is connected to the P line which senses the pressure which inversely proportionally activates the logical element (12) to set value (e.g. pressure limit, fluid flow rate, etc.) which is connected to the tank line and thus regulates the pressure and flow in the tank line. The optimum level or the optimum value for pressure and fluid flow rate may vary with nature and type of fluid.

The first valve section (6) is connected to a hydraulic cylinder (13). The cylinder (13) is connected to a machine element in such a way that the gravitational pull arising out of the self-weight of the machine element is pulling the cylinder rod in the indicated direction.

The second valve section (7) is connected to a hydraulic motor (14). The logic element (12) is a valve which applies selective restriction in the oil passage to the preset pressure.

While operating the valve section1 (6) to open the cylinder (13) and if the cylinder (13), due to the gravitational pull, opening faster than the available pump (3) flow, cavitation occurs in the cylinder. The logical element (12) senses the same and diverts the return oil to the cylinder via the anticavitation valve (8) of the respective valve port.

While the logic element (12) applies restriction in the oil passage, the oil diverted to the cavitating side of the cylinder (13) which is a relatively at a least resistant path for the return oil flow. Because of which the cylinder (13) operation becomes faster resulting in an efficient operation. In case if the selective restriction is not applied, the oil will not get diverted to the cylinder (13) as it is not a least resistant path.

Similarly, while operating the second valve section (7) to operate the motor (14) and while the motor (14) start over running, cavitation will occur. The selective restriction made by the logical element (12) by automatically sensing the cavitation, diverts the returning oil back to the charging line to avoid cavitation and resulting in a better efficiency. While rotating the motor in clockwise direction and while cavitation occurs, through anti cavitation valve (10) oil will be regenerated. While rotating the motor in anti-clockwise direction, when cavitation occurs, the regeneration will happen through the check valve (15) in addition to the inbuilt anti-cavitation valve (11) which increases the regeneration flow of oil to further enhance the efficiency.

The below table shows the test results data in hydraulic system.

| | Test Trial | | |
|---|---|---|---|
| | Trial 1 | Trial 2 | Trial 3 |
| Amb Temperature in deg C. | 34.0 | 33.5 | 33.8 |
| at test duration | | | |
| Engine operating speed, (RPM) | 1200 | 1200 | 1200 |
| Test duration, [symbol] | 20 | 20 | 20 |
| No load pressure of pump1 (bar) | 17.8 | 17.8 | 17.7 |
| Capacity of pump1 (cc) | 34.56 | 34.56 | 34.56 |
| No load pressure of pump2 (bar) | 19.8 | 19.8 | 19.8 |
| Capacity of pump2 (cc) | 16.85 | 16.85 | 16.85 |
| Length of Trench, Meters | 1 [symbol] .0 | 14.2 | 13.0 |
| Depth of Trench, 1 Meter | 1.1 | 1.18 | 1.25 |
| Width of Trench, Meters | 0.90 | 0.90 | 0.90 |
| Volume of material removed, CuM | 14.85 | 15.08 | 14.63 |
| Bucket swing angle, deg | 45 [symbol] 60 | 45 [symbol] 60 | 45 [symbol] 60 |
| Bucket Volume, m3 | 0.27 | 0.27 | 0.27 |
| Amb Temperature in deg C. | 32.8 | 32.8 | 32.5 |
| at test duration | | | |
| Engine operating speed, (RPM) | 1400 | 1400 | 1400 |
| Test duration, [symbol] | 20 | 20 | 20 |
| No load pressure of pump1 (bar) | 18.7 | 18.8 | 18.8 |
| Capacity of pump1 (cc) | 34.56 | 34.56 | 34.56 |
| No load pressure of pump2 (bar) | 22 | 22 | 21.9 |
| Capacity of pump2 (cc) | 16.85 | 16.85 | 16.85 |
| Length of Trench, Meters | 16.2 | 15.8 | 15.5 |
| Depth of Trench, 1 Meter | 1.2 | 1.3 | 1.3 |
| Width of Trench, Meters | 0.90 | 0.90 | 0.90 |
| Volume of material removed, CuM | 17. [symbol] 0 | 18.49 | 18.14 |
| Bucket swing angle, deg | 45 [symbol] 60 | 45 [symbol] 60 | 45 [symbol] 60 |
| Bucket Volume, m3 | 0.27 | 0.27 | 0.27 |
| Amb Temperature in deg C. | 32.5 | 32.5 | 32.6 |
| at test duration | | | |
| Engine operating speed, (RPM) | 1600 | 1600 | 1600 |
| Test duration, [symbol] | 20 | 20 | 20 |
| No load pressure of pump1 (bar) | 20 | 20 | 19.8 |
| Capacity of pump1 (cc) | 34.56 | 34.56 | 34.56 |
| No load pressure of pump2 (bar) | 23 | 22.8 | 23 |
| Capacity of pump2 (cc) | 16.85 | 16.85 | 16.85 |
| Length of Trench, Meters | 17.8 | 16.5 | 17 |
| Depth of Trench, 1 Meter | 1.2 | 1.28 | 1.25 |
| Width of Trench, Meters | 0.90 | 0.90 | 0.90 |
| Volume of material removed, CuM | 19.22 | 19.01 | 19.1 [symbol] |
| Bucket swing angle, deg | 45 [symbol] 0 | 45 [symbol] 60 | 45 [symbol] 60 |
| Bucket Volume, m3 | 0.27 | 0.27 | 0.27 |

[symbol]

indicates data missing or illegible when filed

### LIST OF COMPONENTS WITH RESPECT TO REFERENCE NUMERALS

Tank (1)
Strainer (2)
Pump (3)
Control Valve (4)
Main relief valve (5)
First Valve Section (6)
Second Valve Section (7)
Anti-cavitation cum shock relief valve (8)
Anti-cavitation cum shock relief valve (9)
Anti-cavitation cum shock relief valve (10)
Anti-cavitation cum shock relief valve (11)
Logic element (pilot operated inversely proportional valve) (12)
Options for logic element/Adjustable or non-adjustable means (12a, 12b, 12c & 12d)
Hydraulic Cylinder (13)
Hydraulic Motor (14)
Check valve (15)
Sensors and Controller (16)
HPCO line (17)
Oil Cooler (18)
Return line filter (19)
Power source (20)

1. An apparatus for regulating flow of fluid, comprising:
a dynamic logical element having a pilot operated valve where a pilot line is connected to a pump line of a pump,
said pilot operated valve senses a level of pressure restriction needed in tank line of a direction control valve to activate said dynamic logical element inversely proportionally to set pressure limit for the passage of said fluid to an optimum level in order to regulate the pressure and flow of said fluid in said tank line based on demand or flow of said fluid; and
at least one sensor and controller that detects variable return line flow characteristics such as maximum return line flow rate and minimum return line flow rate of a cylinder and a motor,
wherein said dynamic logical element controls the level of pressure restriction of fluid based on the variable return line flow characteristics of the cylinder which is connected to a first valve section and the motor which is connected to a second valve section of the direction control valve in order to maintain constant maximum allowable pressure limit,
said dynamic logical element senses the cavitation being occurred in said direction control valve and redirects required fluid to desired section of said direction control valve to reduce said cavitation in said direction control valve, and
the dynamic logical element (12) has adjustable or non-adjustable means applies restriction to the fluid flow to set the required pressure in the return line to optimize the effectiveness of regeneration of hydraulic system through anti cavitation function to the required area.

2. The apparatus as claimed in claim 1 comprising:
a check valve which is mounted between tank line and service port of a second valve section, wherein said check valve allows maximum flow when there is a pressure restriction applied by said dynamic logical element.

3. The apparatus as claimed in claim 1, wherein said dynamic logical element senses cavitation occurring in said cylinder to redirect the flow of the fluid to the cavitation side of said cylinder via anti-cavitation valves to increase efficiency.

4. The apparatus as claimed in claim 1, wherein said dynamic logical element senses cavitation occurring in said motor to redirect the flow of said fluid to said cavitation via anti-cavitation valves to increase efficiency.

5. The apparatus as claimed in claim 1, wherein said tank line of said direction control valve is connected back to a tank through a cooler and a return line filter.

6. The apparatus as claimed in claim 1, wherein at least one pressure sensor is mounted on a specific service port which provides an input signal to the controller when there is a flow in the port and the controller sends an appropriate signal to the dynamic logical element to apply selective restriction.

7. The apparatus as claimed in claim 1, wherein said fluid is oil.

8. A system for regulating flow of fluid for reducing cavitation comprising:
a direction control valve;
a dynamic logical element as claimed in claim 1;
a pump connected to said direction control valve which has a main relief valve and a High Pressure Carry Over (HPCO) line of the valve is connected back to a tank via an oil cooler and a return line filter, wherein a tank line of the valve is connected to said dynamic logical element which senses a pressure from a point between the pump and the main relief valve, wherein said dynamic logical element having a pilot operated valve where a pilot line is connected to a pump line of the pump;
a hydraulic cylinder; and
a hydraulic motor.

9. The system for regulating flow of fluid for reducing cavitation as claimed in claim 8 comprising:
a check valve which is mounted between tank line and service port of a second valve section, wherein said check valve allows maximum flow when there is a pressure restriction applied by said dynamic logical element.

10. The system as claimed in claim 8, wherein said dynamic logical element senses cavitation occurring in said cylinder to redirect the flow of the fluid to the cavitation side of said cylinder via anti-cavitation valves to increase efficiency.

11. The system as claimed in claim 8, wherein said dynamic logical element senses cavitation occurring in said motor to redirect the flow of said fluid to said cavitation via anti-cavitation valves to increase efficiency.

12. The system as claimed in claim 8, wherein said tank line of said direction control valve is connected back to a tank through a cooler and a return line filter.

13. The system as claimed in claim 8, wherein at least one pressure sensor is mounted on a specific service port which provides an input signal to the controller when there is a flow in the port and the controller sends an appropriate signal to the dynamic logical element to apply selective restriction.

14. The system as claimed in claim 8, wherein said fluid is oil.
